(19) United States
(12) Patent Application Publication
(10) Pub. No.: US 2025/0140789 A1
(43) Pub. Date: May 1, 2025

(54) ELECTRODE SLURRY, ELECTRODE LAYER, ALL SOLID STATE BATTERY, AND METHOD FOR PRODUCING ELECTRODE SLURRY

(71) Applicant: TOYOTA JIDOSHA KABUSHIKI KAISHA, Toyota-shi (JP)

(72) Inventor: Ryosuke FURUYA, Gotemba-shi (JP)

(73) Assignee: TOYOTA JIDOSHA KABUSHIKI KAISHA, Toyota-shi (JP)

(21) Appl. No.: 18/909,036

(22) Filed: Oct. 8, 2024

(30) Foreign Application Priority Data
Oct. 27, 2023 (JP) 2023-184484

(51) Int. Cl. H01M 4/36; H01M 4/02; H01M 4/131; H01M 4/48; H01M 4/62; H01M 10/0562

(52) U.S. Cl. CPC H01M 4/364; H01M 4/131; H01M 4/48; H01M 4/625; H01M 10/0562; H01M 2004/027; H01M 2300/008

(57) ABSTRACT

A main object of the present disclosure is to provide an electrode slurry of which dispersibility of a fiber shaped conductive material is well. The present disclosure achieves the object by providing an electrode slurry used for an all solid state battery, the electrode slurry containing an electrode active material including a hydroxyl group, a fiber shaped conductive material including an acidic functional group, a solid electrolyte, and a dispersion medium.

### TECHNICAL FIELD

The present disclosure relates to an electrode slurry, an electrode layer, an all solid state battery, and a method for producing an electrode slurry.

### BACKGROUND ART

An all solid state battery is a battery including a solid electrolyte layer between a cathode layer and an anode layer, and one of the advantages thereof is that the simplification of a safety device may be more easily achieved compared to a liquid-based battery including a liquid electrolyte containing a flammable organic solvent. As a method for forming an electrode layer (cathode layer or anode layer) in the all solid state battery, a method known is one using an electrode slurry in which an electrode active material, a conductive material and a solid electrolyte are dispersed in a dispersion medium. In specific, the electrode layer is obtained by pasting the electrode slurry and drying thereof. Also, although it is not a technology relating to an all solid state battery, Patent Literature 1 discloses a carbon nanotube dispersion paste containing a carbon nanotube and an organic solvent.

### CITATION LIST

### Patent Literature

Patent Literature 1: Japanese Patent Application Laid-Open (JP-A) No. 2023-080910

### SUMMARY OF DISCLOSURE

### Technical Problem

The electrode slurry used for an all solid state battery may contain a dispersion medium with low polarity in order to inhibit the decomposition of the solid electrolyte. Also, a fiber shaped conductive material such as a carbon nanotube tends to form a bundle structure. For this reason, even when the fiber shaped conductive material is dispersed in the dispersion medium with low polarity, sufficient dispersion of the fiber-shaped conductive material is difficult.

The present disclosure has been made in view of the above circumstances, and a main object thereof is to provide an electrode slurry of which dispersibility of a fiber shaped conductive material is well.

### Solution to Problem

[1]

An electrode slurry used for an all solid state battery, the electrode slurry comprising:
an electrode active material including a hydroxyl group, a fiber shaped conductive material including an acidic functional group, a solid electrolyte, and a dispersion medium.
   [2]

The electrode slurry according to [1], wherein a proportion of the hydroxyl group in the electrode active material measured by a CO₂-TPD method is 30 μmol/g or more.

[3]

The electrode slurry according to [1] or [2], wherein a proportion of the acidic functional group in the fiber shaped conductive material measured by a potentiometric back titration is 10 μmol/g or more.

[4]

The electrode slurry according to any one of [1] to [3], wherein the electrode active material is a Si-based active material, the fiber shaped conductive material is a carbon nanotube, and the solid electrolyte is a sulfide solid electrolyte.

[5]

The electrode slurry according to any one of [1] to [4], wherein a slurry particle size is 90 μm or less.

[6]

The electrode slurry according to any one of [1] to [5], wherein, when a coating layer is formed by pasting and drying the electrode slurry, a surface roughness of the coating layer based on ISO25178 is 5 μm or less.

[7]

An electrode layer used for an all solid state battery, the electrode layer comprising:
an electrode active material including a hydroxyl group, a fiber shaped conductive material including an acidic functional group, and a solid electrolyte.
   [8]

The electrode layer according to [7], wherein, when the number of an aggregate of the fiber shaped conductive material, of which aspect ratio is 5 or more and 1000 or less and longer side is 2 μm or more in a cross-section of the electrode layer, is confirmed in a region of 50 μm*200 μm, the number of the aggregate is 10 pieces or less.

[9]

The electrode layer according to [7] or [8], wherein a proportion of the hydroxyl group in the electrode active material measured by a CO₂-TPD method is 30 μmol/g or more.

[10]

The electrode layer according to any one of [7] to [9], wherein a proportion of the acidic functional group in the fiber shaped conductive material measured by a potentiometric back titration is 10 μmol/g or more.

[11]

The electrode layer according to any one of [7] to [10], wherein the electrode active material is a Si-based active material, the fiber shaped conductive material is a carbon nanotube, and the solid electrolyte is a sulfide solid electrolyte.

[12]

An all solid state battery comprising a cathode layer, an anode layer, and a solid electrolyte layer arranged between the cathode layer and the anode layer, wherein:
at least one of the cathode layer and the anode layer is the electrode layer according to any one of [7] to.
   [13]

The all solid state battery according to [12], wherein the anode layer is the electrode layer.

[14]

The all solid state battery according to [13], wherein the cathode layer contains a rock salt bed type active material, and the solid electrolyte layer contains a sulfide solid electrolyte.

[15]

A method for producing an electrode slurry used for an all solid state battery, the method comprising:
a first dispersion treatment step of performing a first dispersion treatment by adding an electrode active material including a hydroxyl group, and a fiber shaped conductive material including an acidic functional group to a dispersion medium to obtain a precursor slurry; and
a second dispersion treatment step of performing a second dispersion treatment by adding a solid electrolyte to the precursor slurry to obtain the electrode slurry.

### Advantageous Effects of Disclosure

The present disclosure exhibits an effect of providing an electrode slurry with excellent dispersibility of a fiber shaped conductive material.

### BRIEF DESCRIPTION OF DRAWINGS

FIG. 1 is a schematic cross-sectional view exemplifying the all solid state battery in the present disclosure.

FIG. 2 is a diagram explaining the effect of the present disclosure.

FIG. 3 is a flow chart exemplifying the method for producing the electrode slurry in the present disclosure.

FIG. 4 is a flow chart exemplifying the method for producing the electrode slurry in Reference Examples.

FIGS. 5A and 5B are cross-sectional SEM images of the electrode layers obtained in Examples and Reference Examples.

### DESCRIPTION OF EMBODIMENTS

The electrode slurry, the electrode layer, the all solid state battery and the method for producing the electrode slurry in the present disclosure will be hereinafter explained in details.

### A. Electrode Slurry

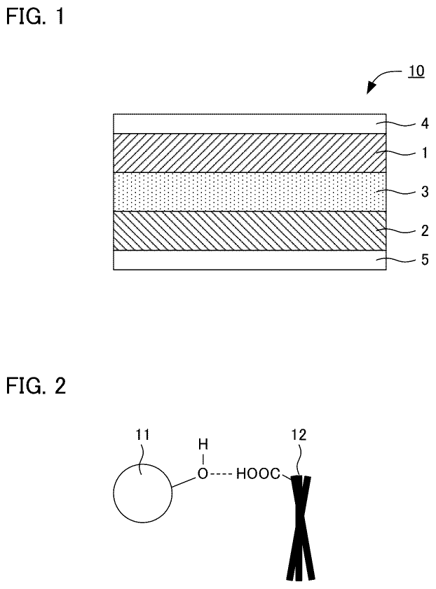

The electrode slurry in the present disclosure is used for producing an electrode layer (cathode layer, anode layer) of an all solid state battery. As shown in FIG. 1, all solid state battery 10 includes cathode layer 1, anode layer 2, and solid electrolyte layer 3 arranged between the cathode layer 1 and the anode layer 2. The electrode slurry in the present disclosure is usually used for producing the cathode layer 1 or the anode layer 2. Also, the electrode slurry in the present disclosure contains an electrode active material including a hydroxyl group, a fiber shaped conductive material including an acidic functional group, a solid electrolyte, and a dispersion medium.

According to the present disclosure, usage of the electrode active material including a hydroxyl group and the fiber shaped conductive material including an acidic functional group in combination allows the electrode slurry to have excellent dispersibility of the fiber shaped conductive material. As described above, the electrode slurry used for the all solid state battery often contains a dispersion medium with low polarity in order to inhibit the decomposition of the solid electrolyte. In particular, in the case of using a solid electrolyte with high reactivity such as a sulfide solid electrolyte, a dispersion medium with low polarity is used. Meanwhile, a fiber shaped conductive material such as a carbon nanotube easily forms a bundle structure. For this reason, sufficient dispersion of the fiber shaped conductive material is difficult even when the fiber shaped conductive material is dispersed in a dispersion medium with low polarity.

In contrast, according to the present disclosure, the electrode active material including a hydroxyl group and the fiber shaped conductive material including an acidic functional group are used in combination. As shown in FIG. 2, the hydroxyl group present on the surface of the electrode active material 11 and the acidic functional group present on the surface of the fiber shaped conductive material 12 interact to inhibit aggregation of the fiber shaped conductive material 12. In the present disclosure, the aggregation of the fiber shaped conductive material 12 is inhibited by the usage of the electrode active material including a hydroxyl group, but in particular, the aggregation of the fiber shaped conductive material 12 is further effectively inhibited when the method described in “D. Method for producing electrode slurry” later is adopted.

### 1. Electrode Active Material

The electrode slurry contains an electrode active material including a hydroxyl group. Whether the electrode active material includes the hydroxyl group or not can be confirmed by an infrared spectroscopy (IR method). In specific, a peak derived from O—H bond usually appears in the range of 3000 cm⁻¹ or more and 3600 cm⁻¹ or less. Also, for example, when the electrode active material is a later described Si-based active material, a peak derived from Si—O bond usually appears in the vicinity of 900 cm⁻¹.

The proportion of the hydroxyl group in the electrode active material can be obtained by a temperature-programmed deposition method using CO₂ (CO₂-TPD method). The proportion of the hydroxyl group in the electrode active material is, for example, 30 μmol/g or more, may be 40 μmol/g or more, and may be 50 μmol/g or more. Meanwhile, the proportion of the hydroxyl group in the electrode active material is, for example 150 μmol/g or less.

Typical examples of the electrode active material including a hydroxyl group may include a Si-based active material. The Si-based active material is an active material mainly composed of Si. The Si-based active material may be a simple substance of Si, may be a Si alloy, and may be a Si oxide. Also, the Si-based active material may include a diamond type crystal phase, may include a silicon clathrate I type crystal phase, and may include a clathrate II type crystal phase. In the clathrate I type or II type crystal phase, a plurality of Si elements form a polyhedron (cage) including pentagons or hexagons. This polyhedron has a space inside to include metal ions such as Li ions, and thus the volume change due to charge and discharge can be suppressed.

The Si-based active material preferably includes the clathrate II type crystal phase as a main phase. Also, the composition of the Si-based active material is not particularly limited, but is preferably represented by NaₓSi₁₃₆ (0≤x≤24). The “x” may be 0 and may be larger than 0. Meanwhile, the “x” may be 20 or less, may be 10 or less, and may be 5 or less. The composition of the Si-based active material may be obtained by, for example, EDX, XRD, XRF, ICP, or an atomic absorption method.

Other examples of the electrode active material including a hydroxyl group may include a carbon-based active material. The carbon-based active material is an active material containing inorganic C (carbon) as a main component, and examples thereof is graphite. Also, additional examples of the electrode active material including a hydroxyl group may include an active material containing at least one kind of Cd, In, Pb, Ga, Ge, Sn, Al, Bi, and Sb.

The electrode active material including a hydroxyl group preferably includes a void inside the primary particle. When there is a void inside the primary particle, the volume change due to charge and discharge can be inhibited. The rate of the void (void rate) in the primary particle is, for example, 4% or more, and may be 10% or more. Meanwhile, the void rate is, for example, 40% or less and may be 20% or less. The void rate may be obtained by, for example, following manners. First, the cross-section of the electrode active material is observed by a SEM (scanning electron microscope) to obtain a picture of the particle. From the obtained picture, the solid part and the void part are distinguished using an image analyzing software, and binarized. The areas of the solid part and the void part are obtained and the void rate (%) is calculated from the below equation.

Void rate (%)=100*(Void part area)/((solid part area)+(void part area))

The electrode active material including a hydroxyl group is preferably a Si-based active material including voids inside the primary particle (porous Si).

The electrode active material may be a cathode active material and may be an anode active material. Examples of the shape of the electrode active material may include a granular shape. The average particle size of the electrode active material is, for example, 0.5 μm or more and 30 μm or less, and may be 0.5 μm or more and 15 μm or less. In the present disclosure, the average particle size regards to volume accumulation particle size D₅₀ measured by a laser diffraction scattering particle distribution measurement device. Also, the proportion of the electrode active material in the solid content of the electrode slurry is not particularly limited, but for example, it is 10 weight % or more and 90 weight % or less, may be 30 weight % or more and 80 weight % or less, and may be 50 weight % or more and 70 weight % or less.

### 2. Fiber Shaped Conductive Material

The electrode slurry contains a fiber shaped conductive material including an acidic functional group. Examples of the acidic functional group may include a carboxy group (—COOH) and a nitro group (—NO₂). Whether the fiber shaped conductive material includes the acidic functional group or not can be confirmed by an infrared spectroscopy (IR method). For example, whether the fiber shaped conductive material includes the carboxy group (—COOH) or not can be confirmed by the presence of the peak derived from O—H bond (peak appears in the range of 3000 cm⁻¹ or more and 3600 cm⁻¹ or less), and the peak derived from C═O bond (peak appears in the range of 1500 cm⁻¹ or more and 1800 cm⁻¹ or less).

The proportion of the acidic functional group in the fiber shaped conductive material can be obtained by a potentiometric back titration. The proportion of the acidic functional group in the fiber shaped conductive material is, for example, 10 μmol/g or more, may be 30 μmol/g or more, and may be 50 μmol/g or more. Incidentally, acetylene black (AB) that is a particulate conductive material may include an acidic functional group (carboxy group), but the proportion thereof is about 5 μmol/g.

Examples of the material of the fiber shaped conductive material including an acidic functional group may include a carbon material, a metal material, and a conductive resin material, and among those, the carbon material is preferable. The reason therefor is that the carbon material is excellent in electron conductivity, light weight, and durability. Examples of the fiber shaped conductive material including an acidic functional group may include a carbon nanotube (CNT) and a carbon nanofiber (CNF). The carbon nanotube (CNT) may be a single layer carbon nanotube (SWCNT), and may be a multilayer carbon nanotube (MWCNT).

The aspect ratio (long side/short side) of the fiber shaped conductive material including an acidic functional group is not particularly limited, but for example, it is 2 or more and 1000 or less, may be 10 or more and 750 or less, and may be 50 or more and 500 or less. The length of the long side of the fiber shaped conductive material is not particularly limited, and for example, it is 0.1 μm or more and 80 μm or less, and may be 0.5 μm or more and 60 μm or less. Meanwhile, the length of the short side of the fiber shaped conductive material is not particularly limited, and for example, it is 0.5 nm or more and 100 nm or less, and may be 1 nm or more and 30 nm or less.

The electrode slurry may contain, in addition to the fiber shaped conductive material including an acidic functional group, a fiber shaped conductive material not including an acidic functional group, and may contain a particulate conductive material. Examples of the particulate conductive material may include a particulate carbon material such as acetylene black (AB) and Ketjen black (KB). The proportion of the fiber shaped conductive material including an acidic functional group with respect to all the conductive materials included in the electrode slurry is, for example, 50 weight % or more, may be 70 weight % or more, and may be 90 weights or more.

The proportion of the fiber shaped conductive material including an acidic functional group in the solid content of the electrode slurry is not particularly limited, and for example, it is 0.05 weight % or more and 5 weight % or less, and may be 0.1 weight % or more and 3 weights or less.

### 3. Solid Electrolyte

The electrode slurry contains a solid electrolyte. The solid electrolyte is usually an inorganic solid electrolyte. Examples of the inorganic solid electrolyte may include a sulfide solid electrolyte, an oxide solid electrolyte, a nitride solid electrolyte, and a halide solid electrolyte. Above all, the sulfide solid electrolyte is preferable. The reason therefor is that the ion conductivity of the sulfide solid electrolyte is high. Also, since the reactivity of the sulfide solid electrolyte is high, it is necessary to use a dispersion medium with low polarity. Even when the dispersion medium with low polarity is used, usage of the electrode active material including a hydroxyl group and the fiber shaped conductive material including an acidic functional group in combination allows the electrode slurry to have excellent dispersibility of the fiber shaped conductive material.

The sulfide solid electrolyte usually contains at least a Li element and a S element. It is preferable that the sulfide solid electrolyte further contains an M element (M is at least one kind of P, As, Sb, Si, Ge, Sn, B, Al, Ga, and In). Also, the sulfide solid electrolyte may contain a halogen element such as F, Cl, Br, and I.

The sulfide solid electrolyte may be a glass-based (amorphous-based) sulfide solid electrolyte, may be a glass ceramic-based sulfide solid electrolyte, and may be a crystal-based sulfide solid electrolyte. The sulfide solid electrolyte may include a crystal phase. Examples of the crystal phase may include a Thio-LISICON type crystal phase, an argyrodite type crystal phase, and a LGPS type crystal phase.

There are no particular limitations on the composition of the sulfide solid electrolyte, and examples thereof may include xLi₂S·(1−x)PS₅ (0.5≤x<1), and yLiI·zLiBr·(100−y−z)(xLi₂S·(1−x)P₂S₅) (0.5≤x<1, 0≤y≤30, 0≤z≤30). In these compositions, it is preferable that the “x” satisfies 0.7≤x≤0.8.

Other examples of the composition of the sulfide solid electrolyte may include Li₄₋ₓM₁₋ₓPₓS₄ (0<x<1). The M is at least one kind of Al, Zn, In, Ge, Si, Sn, Sb, Ga, and Bi. Also, a part of Li may be substituted with at least one kind of Na, K, Mg, Ca and Zn. Also, additional examples of the composition of the sulfide solid electrolyte may include Li_{7-x-2y}PS_{6-x-y}X_{y}. X is at least one kind of F, Cl, Br and I, and x and y satisfy 0≤x, 0≤y. Also, a part of Li may be substituted with at least one kind of Na, K, Mg, Ca and Zn. Further, a part of S may be substituted with oxygen (O).

The shape of the solid electrolyte is, for example, a granular shape. The average particle size of the solid electrolyte is, for example, 0.1 μm or more and 30 μm or less, and may be 0.5 μm or more and 15 μm or less. Also, the proportion of the solid electrolyte in the solid content of the electrode slurry is not particularly limited, and for example, it is 10 weight % or more and 70 weight % or less, may be 20 weight % or more and 60 weight % or less, and may be 30 weight % or more and 50 weight % or less.

### 4. Dispersion Medium

The electrode slurry contains a dispersion medium. The polarity of the dispersion medium is preferably low. The reason therefor is to inhibit the deterioration of the solid electrolyte (sulfide solid electrolyte in particular). The polarity of the dispersion medium may be, for example, specified by Hansen solubility parameters. In specific, the dispersion medium preferably has 4 or less in the polarity section δP of Hansen solubility parameters. The polarity section δP of Hansen solubility parameters can be obtained from Hansen Solubility Parameters: A user's handbook, Second Edition. Boca Raton, Fla: CRC Press. (Hansen, Charles (2007)).

Examples of the dispersion medium may include butyl butylate (δP=2.9), heptane (δP=0), diisobutyl ketone (δP=3.7), tetralin (δP=2), mesitylene (δP=0.6), dibutyl ether (δP=3.4), decane (δP=0), and toluene (δP=1.4). The electrode slurry may contain just one kind of the dispersion medium, and may contain two kinds or more thereof. Also, there are no particular limitations on the solid concentration of the electrode slurry, but for example, it is 30 weight % more and 70 weight % or less, and may be 40 weight % more and 60 weight % or less.

### 5. Electrode Slurry

The electrode slurry may further contain a binder. Examples of the binder may include a fluoride-based binder such as polyvinylidene fluoride (PVDF), a polyvinylidene fluoride-polyhexafluoropropylene copolymer (PVDF-HFP), polytetra fluoroethylene and a fluorine rubber; and a rubber-based binder such as a butadiene rubber, a butadiene hydride rubber, a styrene butadiene rubber (SBR), a styrene butadiene hydride rubber, a nitrile butadiene rubber, a nitrile butadiene hydride rubber, and an ethylene propylene rubber.

The slurry particle size of the electrode slurry is preferably small from the viewpoint of dispersibility. The slurry particle size of the electrode slurry is, for example, 90 μm or less, may be 80 μm or less, may be 60 μm or less, and may be 40 μm or less. Meanwhile, the slurry particle size of the electrode slurry is, for example, 5 μm or more. The slurry particle size of the electrode slurry can be obtained based on JISK5600-2-5.

Also, when the electrode slurry is pasted and dried to form a coating layer, the surface roughness (surface roughness based on ISO25178) of the coating layer is preferably small from the viewpoint of dispersibility. The surface roughness of the coating layer is, for example, 5 μm or less, may be 3 μm or less, and may be 1 μm or less. The coating layer to be measured is preferably formed by blade-pasting the electrode slurry with a gap of 100 μm and drying thereof.

There are no particular limitations on the method for producing the electrode slurry, but examples thereof may include the method described in “D. Method for producing electrode slurry” later.

### B. Electrode Layer

The electrode layer in the present disclosure is used for an all solid state battery, and contains an electrode active material including a hydroxyl group, a fiber shaped conductive material including an acidic functional group, and a solid electrolyte.

According to the present disclosure, usage of the electrode active material including a hydroxyl group and the fiber shaped conductive material including an acidic functional group in combination allows the electrode layer to have excellent dispersibility of the fiber shaped conductive material. The electrode active material, the fiber shaped conductive material, and the solid electrolyte are in the same contents as those described in “A. Electrode slurry” above.

The electrode layer may be a cathode layer containing a cathode active material, and may be an anode layer containing an anode active material. Also, when the cross-section of the electrode layer is observed, the number of an aggregate of the fiber shaped conductive material is preferably little. In specific, when the number of the aggregate of the fiber shaped conductive material, of which aspect ratio is 5 or more and 1000 or less and longer side is 2 μm or more, is confirmed in a region of 50 μm*200 μm, the number of the aggregate is 10 pieces or less, may be 8 pieces or less, may be 5 pieces or less, and may be 3 pieces or less.

The thickness of the electrode layer is not particularly limited, and for example, it is 0.1 μm or more and 1000 μm or less, may be 0.1 μm or more and 500 μm or less, and may be 0.1 μm or more and 100 μm or less. Also, examples of the method for forming the electrode layer may include a method in which the electrode slurry is pasted and dried. The electrode layer is usually used for an all solid state battery. Also, the present disclosure can also provide a battery member used for an all solid state battery, and including at least the electrode layer.

### C. All Solid State Battery

FIG. 1 is a schematic cross-sectional view exemplifying the all solid state battery in the present disclosure. All solid state battery 10 illustrated in FIG. 1 includes cathode layer 1, anode layer 2, solid electrolyte layer 3 arranged between the cathode layer 1 and the anode layer 2, cathode current collector 4 for collecting currents of the cathode layer 1, and anode current collector 5 for collecting currents of the anode layer 2. In the present disclosure, at least one of the cathode layer 1 and the anode layer 2 is the electrode layer described in “B Electrode layer” above.

According to the present disclosure, usage of the above described electrode layer allows the all solid state battery to have low resistance.

### 1. Cathode Layer and Anode Layer

In the present disclosure, the cathode layer may be the above described electrode layer, the anode layer may be the above described electrode layer, and the both of the cathode layer and the anode layer may be the above described electrode layer. The cathode layer contains at least a cathode active material.

For example, when the anode layer is the above described electrode layer, there are no particular limitations on the kind of the cathode active material included in the cathode layer. Examples of the cathode active material may include an oxide active material. Examples of the oxide active material may include a rock salt bed type active material such as LiCoO₂, LiMnO₂, LiNiO₂, LiVO₂, LiNi_{1/3}CO_{1/3}Mn_{1/3}O₂, and LiNi_{0.8}CO_{0.15}Al_{0.05}O₂; a spinel type active material such as LiMn₂O₄, Li₄Ti₅O₁₂, and Li(Ni_{0.5}Mn_{1.5})O₄; and an olivine type active material such as LiFePO₄, LiMnPO₄, LiNiPO₄, and LiCoPO₄.

A coating layer containing Li-ion conductive oxide may be formed on the surface of the oxide active material. The reason therefor is to inhibit the reaction of the oxide active material with the solid electrolyte (particularly a sulfide solid electrolyte). Examples of the Li-ion conductive oxide may include LiNbO₃. The thickness of the coating layer is, for example, 1 nm or more and 30 nm or less.

For example, when the cathode layer is the above described electrode layer, there are no particular limitations on the kind of the anode active material included in the anode layer. Examples of the anode active material may include a metal active material such as Li and Sn; a carbon active material such as graphite; and an oxide active material such as lithium titanate.

The cathode layer may further contain at least one kind of a solid electrolyte, a conductive material, and a binder, in addition to the cathode active material. Similarly, the anode layer may further contain at least one kind of a solid electrolyte, a conductive material, and a binder, in addition to the anode active material. The solid electrolyte, the conductive material and the binder are in the same contents as those described in “A. Electrode slurry” above.

### 2. Solid Electrolyte Layer

The solid electrolyte layer is a layer arranged between the cathode layer and the anode layer, and contains at least a solid electrolyte. The solid electrolyte layer may further contain a binder. The solid electrolyte and the binder are in the same contents as those described in “A. Electrode slurry” above; thus, the descriptions herein are omitted. Also, the thickness of the solid electrolyte layer is, for example, 0.1 μm or more and 1000 μm or less, may be 0.1 μm or more and 500 μm or less, and may be 0.1 μm or more and 100 μm or less.

### 3. Other Constitutions

The all solid state battery in the present disclosure preferably includes a cathode current collector for collecting currents of the cathode layer, and an anode current collector for collecting currents of the anode layer. Examples of the material for the cathode current collector may include SUS, aluminum, nickel, iron, titanium, and carbon. Meanwhile, examples of the material for the anode current collector may include SUS, copper, nickel, and carbon.

The all solid state battery in the present disclosure may further include a restraining jig that applies a restraining pressure along with the thickness direction of the cathode layer, the electrolyte layer and the anode layer. Excellent ion conducting path and electron conducting path may be formed by using the restraining jig. The restraining pressure is, for example, 0.1 MPa or more, may be 1 MPa or more, and may be 5 MPa or more. Meanwhile, the restraining pressure is, for example, 100 MPa or less, may be 50 MPa or less, and may be 20 MPa or less.

### 4. All Solid State Battery

The kind of the all solid state battery in the present disclosure is not particularly limited, but is typically a lithium ion secondary battery. Also, examples of the applications of the all solid state battery may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably used as a power source for driving hybrid electric vehicles (HEV), plug-in hybrid electric vehicles (PHEV), and battery electric vehicles (BEV). Also, the all solid state battery may be used as a power source for moving bodies other than vehicles (such as rail road transportation, vessel and airplane), and may be used as a power source for electronic products such as information processing equipment. Also, there are no particular limitations on the method for producing the all solid state battery, and known methods can be used.

### D. Method for Producing Electrode Slurry

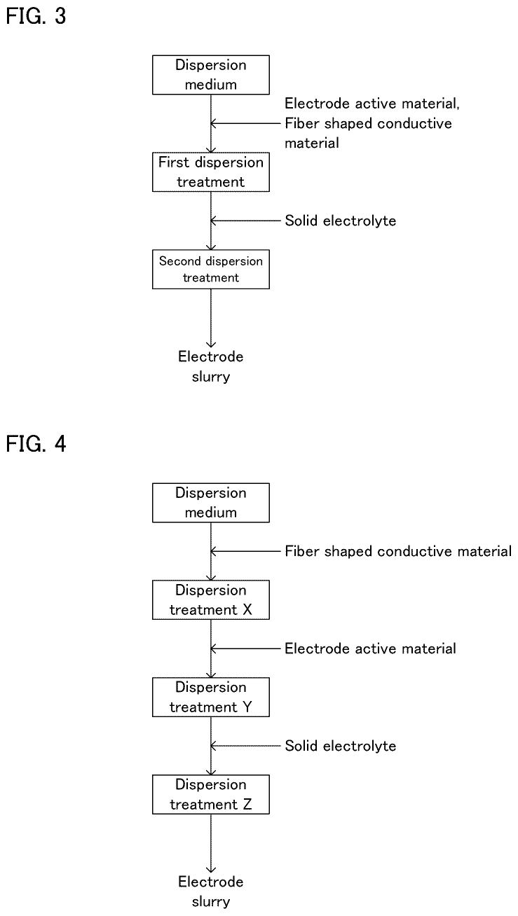

FIG. 3 is a flow-chart exemplifying the method for producing the electrode slurry in the present disclosure. As shown in FIG. 3, a first dispersion treatment is performed by adding an electrode active material including a hydroxyl group, and a fiber shaped conductive material including an acidic functional group to a dispersion medium to obtain a precursor slurry (a first dispersion treatment step). Next, a second dispersion treatment is performed by adding a solid electrolyte to the obtained precursor slurry to obtain the electrode slurry (a second dispersion treatment step).

According to the present disclosure, in the first dispersion treatment step, the electrode active material including a hydroxyl group and the fiber shaped conductive material including an acidic functional group are dispersed at the same time, and then after adding a solid electrolyte, the second dispersion treatment is performed; thus, the electrode slurry with excellent dispersibility of the fiber shaped conductive material can be obtained.

### 1. First Dispersion Treatment Step

The first dispersion treatment step is a step of performing a first dispersion treatment by adding an electrode active material including a hydroxyl group, and a fiber shaped conductive material including an acidic functional group to a dispersion medium to obtain a precursor slurry. The dispersion medium, the electrode active material including a hydroxyl group, and the fiber shaped conductive material including an acidic functional group are in the same contents as those described in “A. Electrode slurry” above.

In the first dispersion treatment step, a first dispersion treatment is performed to a dispersion liquid in which the electrode active material including a hydroxyl group, and the fiber shaped conductive material including an acidic functional group are added to a dispersion medium. To the dispersion medium, a binder may be further added. In other words, the first dispersion treatment may be performed to a dispersion liquid containing the electrode active material, the fiber shaped conductive material, and a binder. Meanwhile, the first dispersion treatment may be performed to the dispersion liquid containing the electrode active material and the fiber shaped conductive material, and then after adding a binder to the dispersion liquid, an additional dispersion treatment may be performed. The additional dispersion treatment is preferably performed before the later described second dispersion treatment step.

Examples of the first dispersion treatment may include an ultrasonic dispersion treatment, and an agitating treatment. There are no particular limitations on the treatment time of the first dispersion treatment, but for example, it is 1 minute or more and 60 minutes or less, and may be 3 minutes or more and 30 minutes or less. The temperature at the time of the first dispersion treatment is not particularly limited, but for example, it is a room temperature.

### 2. Second Dispersion Treatment Step

The second dispersion treatment step is a step of performing a second dispersion treatment by adding a solid electrolyte to the precursor slurry to obtain the electrode slurry. The solid electrolyte is in the same contents as those described in “A. Electrode slurry” above.

In the second dispersion treatment step, the second dispersion treatment is performed by adding the solid electrolyte to the precursor slurry. A binder may be further added to the precursor slurry in which the solid electrolyte is added, and then the second dispersion treatment may be performed.

Examples of the second dispersion treatment may include an ultrasonic dispersion treatment, and an agitating treatment. There are no particular limitations on the treatment time of the second dispersion treatment, but for example, it is 1 minute or more and 60 minutes or less, and may be 3 minutes or more and 30 minutes or less. The temperature at the time of the second dispersion treatment is not particularly limited, but for example, it is a room temperature.

### 3. Electrode Slurry

The electrode slurry to be obtained through the aforementioned each steps is in the same contents as those described in “A. Electrode slurry” above.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

### <Production of Anode Slurry>

An anode slurry was produced in accordance with the flow shown in FIG. 3. In specific, to 2.7 g of a dispersion medium diisobutyl ketone, 0.002 g of a single layer carbon nanotube including a carboxy group (SWCNT, length: 5 μm, fiber diameter: 3 nm, proportion of carboxy group: 55 μmol/g), 1 g of a porous Si including a hydroxyl group (D₅₀: 500 nm, specific surface area: 50 m²/g, proportion of hydroxyl group: 56 μmol/g), and 0.8 g of a binder solution (diisobutyl ketone solution containing PVDF-HFP in the concentration of 5 weight %) were added, and an ultrasonic dispersion treatment (first dispersion treatment) was performed to the product in the conditions of amplitude: 40 μm, frequency: 20 kHz, and 3 minutes, and thereby a precursor slurry was obtained. Next, to the obtained precursor slurry, 1.2 g of a sulfide solid electrolyte (Li₃PS₄-based glass ceramic including LiI and LiBr) was added, and an ultrasonic dispersion treatment (second dispersion treatment) was performed to the product in the conditions of amplitude: 40 μm, frequency: 20 kHz, and 3 minutes, and thereby an anode slurry was obtained.

### <Production of Anode>

The obtained anode slurry was blade-pasted on a roughened Ni foil (anode current collector) with a gap of 340 μm, and dried. Thereby, an anode including an anode current collector and an anode layer was obtained.

### <Production of Solid Electrolyte Layer>

To 0.8 g of heptane, 0.4 g of a sulfide solid electrolyte (Li₃PS₄-based glass ceramic including LiI and LiBr) and 0.05 g of a binder solution (heptane solution containing an acrylonitrile-butadiene rubber in the concentration of 5 weight %) were added, and an ultrasonic dispersion treatment was performed to the product in the conditions of amplitude: 40 μm, frequency: 20 kHz, and 10 minutes, to obtain a slurry. The obtained slurry was blade-pasted on a stainless steel foil (substrate) with a gap of 50 μm, and dried. Thereby, a transferring member including the substrate and a solid electrolyte layer was obtained.

### <Production of Cathode>

To 1 g of butyl butyrate, 2 g of a cathode active material (LiNi_{0.8}Co_{0.15}Al_{0.05}O₂, NCA), 0.03 g of a multilayer carbon nanotube (MWCNT), 0.3 g of a sulfide solid electrolyte (Li₃PS₄-based glass ceramic including LiI and LiBr), and 0.3 g of a binder solution (butyl butyrate solution containing PVDF-HFP in the concentration of 5 weight %) were added, and an ultrasonic treatment was performed to the product in the conditions of amplitude: 40 μm, frequency: 20 kHz, and 10 minutes, to obtain a cathode slurry. The obtained cathode slurry was blade-pasted on an Al foil (cathode current collector) with a gap of 300 μm, and dried. Thereby, a cathode including a cathode current collector and a cathode layer was obtained.

### <Production of Battery>

The anode and the transferring member were overlapped so that the anode layer in the anode and the solid electrolyte layer in the transferring member faced to each other, and roll-pressing was performed to the product in the conditions of the linear load of 3t/cm and a room temperature, to obtain an anode layered body. Similarly, the cathode and the transferring member were overlapped so that the cathode layer in the cathode and the solid electrolyte layer in the transferring member faced to each other, and roll-pressing was performed to the product in the conditions of the linear load of 4t/cm and a room temperature, to obtain a cathode layered body. After that, the cathode layered body and the anode layered body were overlapped so that the solid electrolyte layers faced to each other, and the solid electrolyte layers were bonded. Thereby, a battery was obtained.

### Examples 2 to 5

An anode slurry was obtained in the same manner as in Example 1 except that the particle size and the specific surface area of the porous Si were respectively changed to the values shown in Table 1. A battery was respectively obtained in the same manner as in Example 1 except that the obtained anode slurry was respectively used.

### Example 6

An anode slurry was obtained in the same manner as in Example 1 except that a multilayer carbon nanotube including a carboxy group (MWCNT, length: 5 μm, fiber diameter: 150 nm, proportion of carboxy group: 60 μmol/g) was used instead of SWCNT. A battery was obtained in the same manner as in Example 1 except that the obtained anode slurry was used.

### Examples 7 to 10

An anode slurry was obtained in the same manner as in Example 6 except that the particle size and the specific surface area of the porous Si were respectively changed to the values shown in Table 1. A battery was respectively obtained in the same manner as in Example 1 except that the obtained anode slurry was respectively used.

### Example 11

An anode slurry was obtained in the same manner as in Example 1 except that a solid Si nano particle was used instead of the porous Si. A battery was obtained in the same manner as in Example 1 except that the obtained anode slurry was used.

### Examples 12 to 13

An anode slurry was obtained in the same manner as in Example 1 except that the particle size and the specific surface area of the Si nano particle were respectively changed to the values shown in Table 1. A battery was respectively obtained in the same manner as in Example 1 except that the obtained anode slurry was respectively used.

### Example 14

An anode slurry was obtained in the same manner as in Example 6 except that a solid Si nano particle was used instead of the porous Si. A battery was obtained in the same manner as in Example 1 except that the obtained anode slurry was used.

### Reference Example 1

An anode slurry was produced in accordance with the flow shown in FIG. 4. In specific, to 2.7 g of a dispersion medium diisobutyl ketone, 0.002 g of SWCNT and 0.8 g of a binder solution were added, and an ultrasonic treatment (dispersion treatment X) was performed in the conditions of amplitude: 40 μm, frequency: 20 kHz, and 3 minutes, to obtain a first precursor slurry. Next, to the obtained first precursor slurry, 1 g of porous Si was added, and an ultrasonic treatment (dispersion treatment Y) was performed to the product in the conditions of amplitude: 40 μm, frequency: 20 kHz, and 3 minutes, to obtain a second precursor slurry. Next, to the obtained second precursor slurry, 1.2 g of a sulfide solid electrolyte was added, and an ultrasonic treatment (dispersion treatment Z) was performed to the product in the conditions of amplitude: 40 μm, frequency: 20 kHz, and 3 minutes, to obtain an anode slurry. Incidentally, each materials used for the anode slurry were the same as those in Example 2. Also, a battery was obtained in the same manner as in Example 1 except that the obtained anode slurry was used.

### Reference Example 2

An anode slurry was obtained in the same manner as in Reference Example 1 except that the MWCNT used in Example 6 was used instead of SWCNT. Also, a battery was obtained in the same manner as in Example 1 except that the obtained anode slurry was used.

### Reference Example 3

An anode slurry was obtained in the same manner as in Reference Example 1 except that a solid Si nano particle was used instead of the porous Si. A battery was obtained in the same manner as in Example 1 except that the obtained anode slurry was used.

### Reference Example 4

An anode slurry was obtained in the same manner as in Reference Example 2 except that a solid Si nano particle was used instead of the porous Si. A battery was obtained in the same manner as in Example 1 except that the obtained anode slurry was used.

TABLE 1

| | | | | Specific | |
|---|---|---|---|---|---|
| | | | Particle | Surface | |
| | Conductive | Active | size | area | Dispersion |
| | material | material | (nm) | (m²/g) | style |
| Example 1 | SWCNT | Porous Si | 500 | 50 | at the same time |
| Example 2 | SWCNT | Porous Si | 1000 | 50 | at the same time |
| Example 3 | SWCNT | Porous Si | 1000 | 100 | at the same time |
| Example 4 | SWCNT | Porous Si | 1000 | 300 | at the same time |
| Example 5 | SWCNT | Porous Si | 1000 | 600 | at the same time |
| Example 6 | MWCNT | Porous Si | 500 | 50 | at the same time |
| Example 7 | MWCNT | Porous Si | 1000 | 50 | at the same time |
| Example 8 | MWCNT | Porous Si | 1000 | 100 | at the same time |
| Example 9 | MWCNT | Porous Si | 1000 | 300 | at the same time |
| Example 10 | MWCNT | Porous Si | 1000 | 600 | at the same time |
| Example 11 | SWCNT | Si nano particle | 50 | 50 | at the same time |
| Example 12 | SWCNT | Si nano particle | 100 | 20 | at the same time |
| Example 13 | SWCNT | Si nano particle | 200 | 10 | at the same time |
| Example 14 | MWCNT | Si nano particle | 50 | 50 | at the same time |
| Ref. Ex. 1 | SWCNT | Porous Si | 1000 | 50 | one by one |
| Ref. Ex. 2 | MWCNT | Porous Si | 1000 | 50 | one by one |
| Ref. Ex. 3 | SWCNT | Si nano particle | 50 | 50 | one by one |
| Ref. Ex. 4 | MWCNT | Si nano particle | 50 | 50 | one by one |

### [Evaluation]

### <Slurry Particle Size>

The slurry particle size was respectively measured using the anode slurries produced in Examples 1 to 14 and Reference Examples 1 to 4. In specific, the slurry particle size was measured based on JISK5600-2-5. The results are shown in Table 2.

### <Surface Roughness Based on ISO25178>

The anode slurry produced in Examples 1 to 14 and Reference Examples 1 to 4 was respectively blade-pasted on a roughened Ni foil with a gap of 100 μm, and dried. Thereby, evaluation samples were obtained. The surfaces of the obtained evaluations samples were measured using a digital microscope (VHX-8000 from KEYENCE CORPORATION) with a 500 magnification field of view, and the surface roughness based on ISO25178 was respectively obtained. The results are shown in Table 2.

### <Cell Resistance>

The resistance of the batteries obtained in Examples 1 to 14 and Reference Examples 1 to 4 was respectively measured. In specific, the batteries were CCCV charged at C/10 until 4.35 V, and then CCCV discharged at C/3 until 3.35 V. After that, discharge at 7 C was further performed, and cell resistances were obtained from the voltage change in 10 seconds and the current value. The results are shown in Table 2.

### <Electron Conductivity>

Electron conductivity was measured using anodes produced in Examples 1 to 14 and Reference Examples 1 to 4. In specific, the anode was respectively punched out into 1 cm², and two of the anode punched out were overlapped so that the anode layers faced to each other. An overlapped layered body was restrained in a thickness direction, the resistance was measured, and the electron conductivity was obtained. The results are shown in Table 2.

### <The Number of Aggregate>

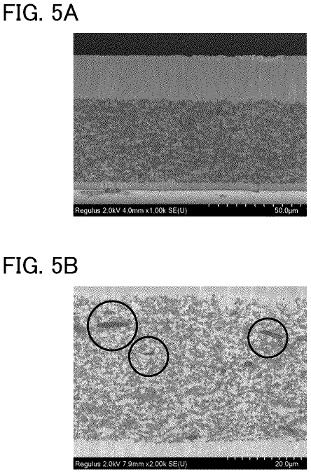

The number of an aggregate of the conductive material was counted using the anode layers produced in Examples 1 to 14 and Reference Examples 1 to 4. In specific, the cross-sections of the anode layers were observed using a scanning electron microscope (SEM, FE-SEM SU-8200 from Hitachi) with 400 magnification field of view. In the observation, the number of an aggregate of the conductive material, of which aspect ratio was 5 or more and 1000 or less and longer side was 2 μm or more, was confirmed in a region of 50 μm*200 μm. This operation was performed 10 times, and the average value was respectively determined as the number of the aggregate of the conductive material. The results are shown in Table 2. Also, as shown in FIG. 5A, the aggregate of the conductive material was rarely confirmed in the anode layer produced in Example 1. Meanwhile, as shown in FIG. 5B, a plurality of aggregates (parts surrounded with black circles) were confirmed in the anode layer produced in Reference Example 1.

TABLE 2

| | Slurry | | | | |
|---|---|---|---|---|---|
| | particle | Surface | Cell | Electron | The |
| | size | roughness | resistance | conductivity | number of |
| | (μm) | (μm) | (Ω · cm²) | (mS/m) | aggregate |
| Example 1 | 30 | 0.4 | 23.4 | 2.94 | 3 |
| Example 2 | 30 | 0.5 | 23.3 | 2.72 | 1 |
| Example 3 | 30 | 0.4 | 22.3 | 2.95 | 1 |
| Example 4 | 40 | 0.6 | 21.1 | 2.88 | 2 |
| Example 5 | 50 | 0.4 | 23.3 | 3.04 | 1 |
| Example 6 | 30 | 0.5 | 23.2 | 2.32 | 6 |
| Example 7 | 30 | 0.8 | 24.4 | 2.09 | 8 |
| Example 8 | 30 | 0.6 | 24.1 | 2.22 | 7 |
| Example 9 | 30 | 0.7 | 22.8 | 2.15 | 8 |
| Example 10 | 40 | 0.4 | 24.3 | — | 5 |
| Example 11 | 30 | 0.2 | 19.6 | 2.87 | 2 |
| Example 12 | 90 | 9.5 | 21.5 | 1.88 | 8 |
| Example 13 | 90 | 8.7 | 23.2 | 1.76 | 9 |
| Example 14 | 30 | 0.6 | 20.3 | 2.11 | 5 |
| Ref. Ex. 1 | >100 | 10.3 | 25.0 | 1.72 | 17 |
| Ref. Ex. 2 | >100 | 9.0 | 27.2 | 1.31 | 14 |
| Ref. Ex. 3 | >100 | 10.5 | 24.8 | 1.82 | 13 |
| Ref. Ex. 4 | >100 | 10.2 | 26.8 | 1.35 | 14 |

As shown in Table 1, it was confirmed that the dispersibility of the fiber shaped conductive material in the electrode slurries in Examples 1 to 14 and Reference Examples 1 to 4 were excellent. In this manner, an electrode slurry with excellent dispersibility of the fiber shaped conductive material was obtained when the electrode active material including a hydroxyl group and the fiber shaped conductive material including an acid functional group were used in combination.

Above all, in Examples 1 to 5, compared to Reference Example 1, respectively, it was confirmed that the slurry particle size was smaller, the surface roughness was smaller, the cell resistance was smaller, the electron conductivity was higher, and the number of the aggregate was less. Similarly, in Examples 6 to 10, compared to Reference Example 2, it was confirmed that the slurry particle size was smaller, the surface roughness was smaller, the cell resistance was smaller, the electron conductivity was higher, and the number of the aggregate was less. In this manner, in the present disclosure, it was confirmed that the dispersion at the same time was more preferable than one by one dispersion. Also, based on the results, in the present disclosure, the average particle size D₅₀ of the porous Si is preferably 300 nm or more and 1200 nm or less. The average particle size D₅₀ of the porous Si may be 500 nm or more and 1000 nm or less. Also, in the present disclosure, the specific surface area of the porous Si is preferably 30 m²/g or more and 800 m²/g or less. The specific surface area of the porous Si may be 50 m²/g or more and 600 m²/g or less.

Also, in Example 11, compared to Reference Example 3, it was confirmed that the slurry particle size was smaller, the surface roughness was smaller, the cell resistance was smaller, the electron conductivity was higher, and the number of the aggregate was less. Also, in Example 14, compared to Reference Example 4, it was confirmed that the slurry particle size was smaller, the surface roughness was smaller, the cell resistance was smaller, the electron conductivity was higher, and the number of the aggregate was less. Also, based on the results of Example 11 and Example 12, in the present disclosure, the particle size D₅₀ of the Si nano particle is preferably less than 100 nm. The average particle size D₅₀ of the Si nano particle may be 80 nm or less, and may be 60 nm or less. Meanwhile, the average particle size D₅₀ of the Si nano particle may be 20 nm or more. Also, in the present disclosure, the specific surface area of the Si nano particle is preferably larger than 20 m²/g. The specific surface area of the Si nano particle may be 30 m²/g or more, and may be 40 m²/g or more. Meanwhile, the specific surface area of the Si nano particle may be 70 m²/g or less.

### REFERENCE SIGNS LIST

1 cathode layer
2 anode layer
3 solid electrolyte layer
4 cathode current collector
5 anode current collector
10 all solid state battery

What is claimed is:

1. An electrode slurry used for an all solid state battery, the electrode slurry comprising:
an electrode active material including a hydroxyl group, a fiber shaped conductive material including an acidic functional group, a solid electrolyte, and a dispersion medium.

2. The electrode slurry according to claim 1, wherein a proportion of the hydroxyl group in the electrode active material measured by a CO₂-TPD method is 30 μmol/g or more.

3. The electrode slurry according to claim 1, wherein a proportion of the acidic functional group in the fiber shaped conductive material measured by a potentiometric back titration is 10 μmol/g or more.

4. The electrode slurry according to claim 1, wherein the electrode active material is a Si-based active material, the fiber shaped conductive material is a carbon nanotube, and the solid electrolyte is a sulfide solid electrolyte.

5. The electrode slurry according to claim 1, wherein a slurry particle size is 90 μm or less.

6. The electrode slurry according to claim 1, wherein, when a coating layer is formed by pasting and drying the electrode slurry, a surface roughness of the coating layer based on ISO25178 is 5 μm or less.

7. An electrode layer used for an all solid state battery, the electrode layer comprising:
an electrode active material including a hydroxyl group, a fiber shaped conductive material including an acidic functional group, and a solid electrolyte.

8. The electrode layer according to claim 7, wherein, when the number of an aggregate of the fiber shaped conductive material, of which aspect ratio is 5 or more and 1000 or less and longer side is 2 μm or more in a cross-section of the electrode layer, is confirmed in a region of 50 μm*200 μm, the number of the aggregate is 10 pieces or less.

9. The electrode layer according to claim 7, wherein a proportion of the hydroxyl group in the electrode active material measured by a CO₂-TPD method is 30 μmol/g or more.

10. The electrode layer according to claim 7, wherein a proportion of the acidic functional group in the fiber shaped conductive material measured by a potentiometric back titration is 10 μmol/g or more.

11. The electrode layer according to claim 7, wherein the electrode active material is a Si-based active material, the fiber shaped conductive material is a carbon nanotube, and the solid electrolyte is a sulfide solid electrolyte.

12. An all solid state battery comprising a cathode layer, an anode layer, a solid electrolyte layer arranged between the cathode layer and the anode layer, wherein
at least one of the cathode layer and the anode layer is the electrode layer according to claim 7.

13. The all solid state battery according to claim 12, wherein the anode layer is the electrode layer.

14. The all solid state battery according to claim 13, wherein the cathode layer contains a rock salt bed type active material, and the solid electrolyte layer contains a sulfide solid electrolyte.

15. A method for producing an electrode slurry used for an all solid state battery, the method comprising:
a first dispersion treatment step of performing a first dispersion treatment by adding an electrode active material including a hydroxyl group, and a fiber shaped conductive material including an acidic functional group to a dispersion medium to obtain a precursor slurry; and
a second dispersion treatment step of performing a second dispersion treatment by adding a solid electrolyte to the precursor slurry to obtain the electrode slurry.
